(19) United States
(12) Patent Application Publication
(10) Pub. No.: US 2006/0010260 A1
(43) Pub. Date: Jan. 12, 2006

(54) Direct memory access (DMA) controller and bus structure in a master/slave system

(76) Inventor: Hon C. Fung, Flower Mound, TX (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/886,401

(22) Filed: Jul. 7, 2004

(51) Int. Cl. G06F 13/28

(52) U.S. Cl. 710/22

(57) ABSTRACT

Direct memory access (DMA) controllers of a master/slave computer system and methods for transferring data under a DMA protocol in a master/slave system are disclosed herein. A DMA controller according to the present application comprising a first data path connected to a memory bus, wherein the memory bus is in communication with at least one memory device. The DMA controller also comprises a second data path connected to a peripheral bus, wherein the peripheral bus is in communication with at least one peripheral device. Also, the DMA controller comprises a device for transferring data between one of the at least one memory device and one of the at least one peripheral device.

### TECHNICAL FIELD

The present application relates to the transfer of data from one component to another. More particularly, the present application relates to using a direct memory access (DMA) scheme to transfer data in a master/slave computer system.

### BACKGROUND

Many computer systems include direct memory access (DMA) for transferring data from one component to another. The advantage of DMA is that the main processor, or central processing unit (CPU), of the computer system is not involved in the actual data transfer. By using DMA, a data transfer process can be carried out at the same time that the CPU is executing steps of an application unrelated to the data transfer.

Typically, DMA is managed by a device referred to as a DMA controller. During a “read” command, for example, the DMA controller arranges for a memory device, to transmit stored data to an input/output (I/O) device, or peripheral device. Depending on whether the DMA system is part of a computer system configured as a “master/slave” system or a computer system configured as a “non-master/slave” system, the DMA controller itself may or may not actually handle the data. For instance, in a master/slave system, the DMA controller acts as a relay to receive and re-transmit the data as it is moved from one component to another.

FIG. 1 is a block diagram of a conventional DMA circuit 10 of a “non-master/slave” computer system. In this DMA circuit 10, the DMA controller 12 is not actually in the data path itself, but it controls the data transfer nonetheless. When a data read procedure is to be performed, the DMA controller 12 appropriates address signals and control signals to a memory device 14, instructing the memory device 14 to put the desired data out on a bus 16. The DMA controller 12 also appropriates control signals to a peripheral device 18 instructing it to read the data from the bus 16. In this manner, the data is passed directly from the memory device 14 to the peripheral device 18 via the bus 16 and the DMA controller 12 never touches the data.

FIG. 2 is a block diagram of a conventional DMA circuit 20 of a “master/slave” computer system. A memory device 22, a peripheral device 24, and a DMA controller 26 are all connected to and share a common bus 28. The DMA controller 26 comprises a temporary storage unit 30 for temporarily storing data during the data transfer. The DMA controller 26 also includes a data communication link 32, which connects the DMA controller 26 to the common bus 28, allowing the DMA controller 26 to handle the data for transmitting or receiving data to or from the common bus 28.

In a master/slave system, there will always be one master and one slave involved in a data transfer. Since the memory device 22 and the peripheral device 24 are both slave devices, they cannot communicate with each other directly as in the case of the non-master/slave system of FIG. 1. Therefore, the DMA controller 26, acting as a master device, relays the data from one slave to another. In this respect, two master/slave transactions are required to transfer the data.

During a data read procedure, for example, two separate transactions are performed to get the desired data from the memory device 22 to the peripheral device 24. In a first data transfer stage, a first master/slave communication path is established along the common bus 28 between the DMA controller 26 (master) and the memory device 22 (slave). The DMA controller 26 sends address signals and control signals to the memory device 22 requesting access to the desired data stored in a particular memory location in the memory device 22. In response, the memory device 22 sends the requested data out onto the common bus 28. Then, the DMA controller 26 reads the data from the common bus 28 via data path 32 and stores the data in the temporary storage unit 30.

At a subsequent time, a second data transfer stage of the read procedure is performed. During the second data transfer stage, a second master/slave communication path is established along the common bus 28 between the DMA controller 26 and the peripheral device 24. The DMA controller 26 sends control signals to the peripheral device 24 to indicate that data is being transferred. Then, the DMA controller 26 transmits the data from its temporary storage unit 30 onto the common bus 28 via data path 32, and the peripheral device 24, as instructed, reads the data from the common bus 28. From FIG. 2, it is noted that the common bus 28, DMA controller 26, and data path 32 are occupied during each data transfer stage either reading from memory or writing to the peripheral.

FIG. 3 is a timing diagram of the above-mentioned two-stage data transfer process according to the conventional DMA circuit 20 of a master/slave system. The signals of FIG. 3 represent the activity of the DMA controller 26. For instance, the top signal represents when the DMA controller 26 reads data from memory, i.e. “READ FROM MEMORY”, and the bottom signal represents when the DMA controller writes data to the peripheral, i.e. “WRITE TO PERIPHERAL”. A first packet of data, referred to as DATA 1, is read from memory (i.e., memory device 22) during a first time interval t₁ and stored temporarily. DATA 1 is then written from the DMA controller 26 to a peripheral (i.e., peripheral device 24) during a second time interval t₂. After the first data packet DATA 1 has been successfully transferred during time intervals t₁ and t₂, a second data packet DATA 2 may be read from memory and subsequently written to the peripheral during time intervals t₃ and t₄. After t₄, a third data packet DATA 3 can be transferred, and so on. From this timing diagram, it is noted that two time intervals are required for the transfer of each data packet.

Although the conventional DMA circuit 20 of FIG. 2 of the master/slave system provides the benefit that the CPU does not require intervention to transfer data, it should be pointed out, however, that the conventional DMA circuit 20 is limited by how much data can be transferred from one slave to another over a given time. This limitation creates a bottleneck situation as a result of the fact that only one data transfer stage can occur on the common bus 28 at any one time. Also, a bottleneck occurs at the DMA controller 26 itself, which is only capable of either transmitting or receiving data, but not both, at any one time. This bottleneck occurs because the data path 32 from the DMA controller 26 to the bus 28 is limited to communication in only one direction. As a result of these bottlenecks, the conventional system 20 is limited in its efficiency concerning the speed of data transfer from one slave to another. Thus, given the conventional circuitry of a master/slave system, it requires two time intervals to successfully transfer data from one slave to another.

Some solutions have been proposed to overcome the deficiencies of the conventional system. One solution has been to increase the operating frequency of the internal bus. However, this complicates the design of the master/slave interfaces and typically requires that the slaves be re-designed in order that they will be able to operate at the higher speed. For those slaves already in existence or those in the process of being designed, increasing the internal bus frequency might require the additional work of re-designing these components.

A new structure, which eliminates the undesirable bottlenecks resulting from the conventional system, is desired. Such a new system should more efficiently transfer data in a slave-to-slave transaction in a master/slave system using DMA. It would further be beneficial for such a new system to operate with a frequency that does not necessarily have to be increased in order to achieve these objectives. The present disclosure provides a system to increase the efficiency of such data transfers and to reduce the bottlenecks of the prior art without increasing the operating frequency of the DMA system.

### SUMMARY

Disclosed herein are systems and methods for transferring data in a master/slave computer system using a direct memory access (DMA) protocol. An embodiment of a DMA controller of a master/slave computer system, disclosed herein, comprises a first data path connected to a memory bus, the memory bus being in communication with at least one memory device. The DMA controller also comprises a second data path connected to a peripheral bus, the peripheral bus being in communication with at least one peripheral device. In addition, the DMA controller comprises means for transferring data between one of the at least one memory device and one of the at least one peripheral device.

A method, as described herein, for transferring data from one slave to another comprises reading a first data packet from a first bus and temporarily storing the first data packet in a first temporary storage unit. The method also includes writing the first data packet from the first temporary storage unit onto a second bus and simultaneously reading a second data packet from the first bus.

### BRIEF DESCRIPTION OF THE DRAWINGS

Many aspects of the embodiments of the present disclosure can be better understood with reference to the following drawings. Like reference numerals designate corresponding parts throughout the several views.

FIG. 1 is a block diagram of a conventional direct memory access (DMA) circuit of a non-master/slave system.

FIG. 2 is a block diagram of a conventional DMA circuit of a master/slave system.

FIG. 3 is a timing diagram of data transfer using the DMA circuit of FIG. 2 for the master/slave system.

FIG. 4 is a block diagram of an embodiment of an improved DMA circuit in a master/slave system according to the teachings of the present application.

FIG. 5 is a block diagram of an embodiment of the DMA controller shown in FIG. 4.

FIG. 6 is a timing diagram of data transfer using the DMA circuit of FIG. 4 for a master/slave system.

FIG. 7 is a block diagram of another embodiment of an improved DMA circuit in a master/slave system according to the teachings of the present application.

FIG. 8 is a block diagram of an embodiment of the DMA controller shown in FIG. 7.

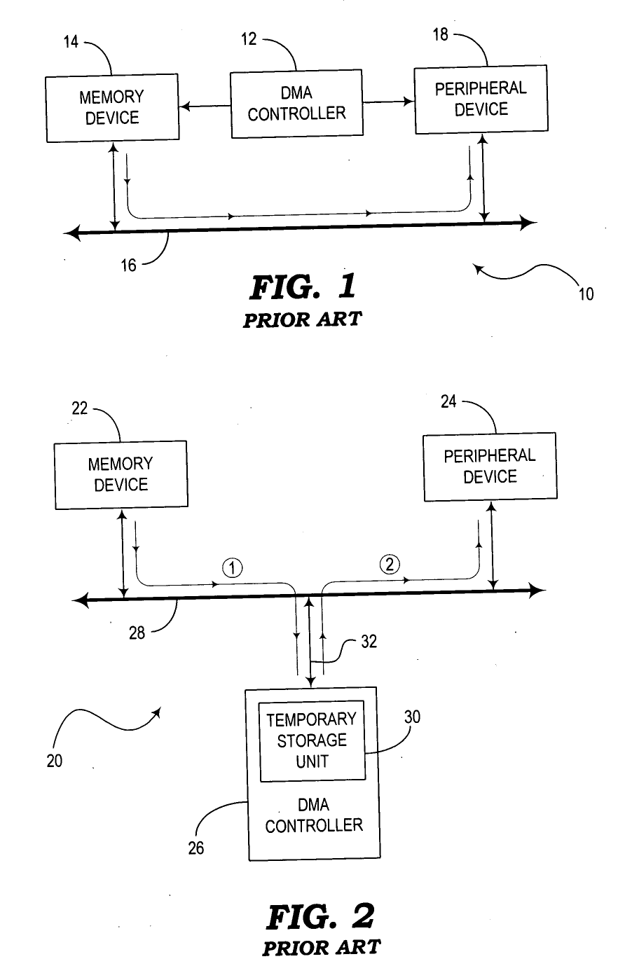

### DETAILED DESCRIPTION

The present application overcomes the efficiency issues of the prior art by allowing a greater amount of data to be transferred between two slaves in a master/slave system using a direct memory access (DMA) data transfer process. By splitting the common bus into two or more separate buses and changing the design of the conventional DMA controller, the aforementioned bottlenecks can be reduced such that the rate of data transfer can essentially be increased by a factor of at least two. Therefore, without increasing the operating frequency of the computer system and without changing the design of the slave devices, a DMA data transfer procedure can be performed more quickly using the DMA controller discussed herein. According to the present application, the improved DMA controller can 1) read from the memory device and 2) simultaneously write to the peripheral device in order to more efficiently transfer data from one slave to another. And in an alternative embodiment, the DMA controller can perform a plurality of simultaneous reads and writes, resulting in a more pronounced increase in efficiency.

The present application relates to DMA circuits of a master/slave computer system, DMA controllers, and methods for performing a DMA data transfer in a master/slave computer system. One of several embodiments disclosed herein includes a DMA circuit that comprises a memory device, a peripheral device, and a DMA controller having first and second data paths. The DMA circuit further comprises a first bus to which the memory device and the first data path of the DMA controller are connected and a second bus to which the peripheral device and the second data path of the DMA controller are connected. The DMA controller comprises first and second temporary storage units and first and second switches. The first switch provides a first state to electrically couple the first temporary storage unit to the first bus and a second state to electrically couple the second temporary storage unit to the first bus. The second switch provides a first state to electrically couple the first temporary storage unit to the second bus and a second state to electrically couple the second temporary storage unit to the second bus.

FIG. 4 is a block diagram of an embodiment of an improved DMA circuit 40 within a master/slave computer system. The DMA circuit 40 according to this embodiment includes a memory device 42, a peripheral device 44, and a DMA controller 46. Instead of a single common bus, the DMA circuit 40 includes two buses 48 and 50.

The memory device 42 and the DMA controller 46 are configured to interface along bus 48, referred to herein as a “memory bus.” Although only one memory device is shown in FIG. 4, more than one memory device may be connected to the memory bus 48. In this respect, any one of a plurality of memory devices may be accessed along this memory bus 48. In an extreme case where only one memory device 42 is connected to the memory bus 48, the memory bus 48 may be replaced by a direct connection between the memory device 42 and DMA controller 46.

The peripheral device 44 and the DMA controller 46 are configured to interface along bus 50, referred to herein as a “peripheral bus.” Although only one peripheral device is shown in FIG. 4, more than one peripheral device may be connected to the peripheral bus 50. In this respect, any one of a plurality of peripheral devices may be accessed along the peripheral bus 50. If only one peripheral device 44 is connected to the peripheral bus 50, the peripheral bus 50 may be replaced by a direct connection between the peripheral device 44 and the DMA controller 46.

In addition, the DMA controller 46 is configured such that it includes two data paths 52 and 54 for connection to the respective buses 48 and 50. By splitting the convention bus into two buses—memory bus 48 and peripheral bus 50—the DMA controller 46 can interact with the memory device 42 along memory bus 48 and data path 52 at the same time that it is interacting with the peripheral device 44 along peripheral bus 50 and data path 54. These simultaneous interactions can be performed without signals crossing on a common bus or common data path. Using this parallel configuration, the DMA controller 46 can read one data packet from the memory device 42 and simultaneously write another data packet to the peripheral device 44.

FIG. 5 is a block diagram of an embodiment of the DMA controller 46 shown in FIG. 4. In this embodiment, the DMA controller 46 includes a first temporary storage unit 60 and a second temporary storage unit 62. The DMA controller 46 also includes a first switch 64 and a second switch 66. The temporary storage units 60, 62 are connected in an alternating manner to the memory bus 48 via switch 64. Also, the storage units are connected in an alternating manner to the peripheral bus 50 via switch 66. The DMA controller 46 may include a processing or controlling device (not shown) for setting the state of the switches 64 and 66 as necessary.

The switches 64 and 66 may be formed from any suitable electrical and/or mechanical components, such as transistors, electromechanical devices, mechanical toggle switches, or other switching type devices. Alternatively, switches 64 and 66 may be replaced by multiplexers or demultiplexers, depending on the direction in which the data is moving. In another embodiment, the switches 64 and 66 may comprise a combination of logic components for providing the desired switching functions described herein.

As will be described in more detail below, the state of the switches 64 and 66 will be set in such a manner that switch 64 electrically couples the memory bus 48 with one of the temporary storage units 60, 62 while switch 66 electrically couples the peripheral bus 50 with the other temporary storage unit 60, 62. The switches are therefore configured to operate cooperatively so as to simultaneously change states with respect to each other, thereby connecting one temporary storage unit with one bus at any time. In this regard, each temporary storage unit will only be coupled to one bus at a time.

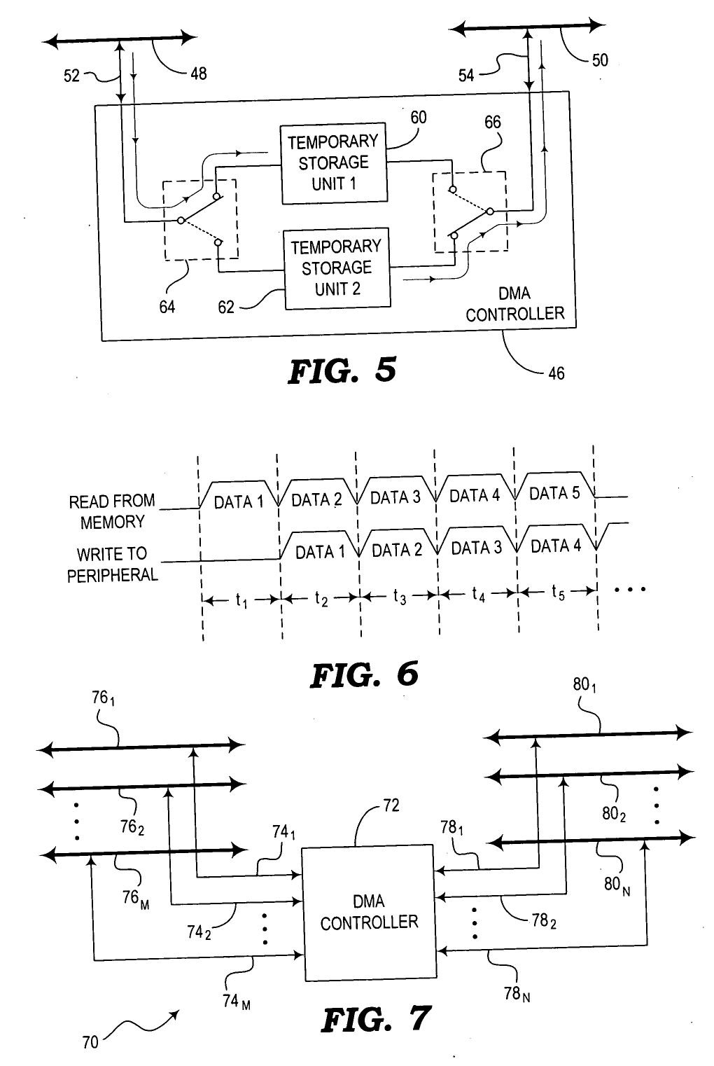

As illustrated in FIG. 5, the switches 64 and 66 are set in an initial state such that switch 64 couples memory bus 48 to the first temporary storage unit 60 and switch 66 couples peripheral bus 50 to the second temporary storage unit 62. It should be noted, however, that the initial state of the switches, as shown, is merely for illustrative purposes and it will be understood that the initial state may be reversed. Operation of the DMA circuit 40 of FIG. 4, and particularly the DMA controller 46 of FIG. 5, will be explained with respect to the exemplary timing diagram of FIG. 6.

FIG. 6 illustrates a timing diagram showing an example of how several consecutive data packets DATA 1, DATA 2, etc., may be transferred using the DMA circuit 40 of FIG. 4. It is assumed in this example that the initial state of the switches is configured as shown in FIG. 5. It should be noted that this initial state of the switches may be reversed, depending on previous data transfer operations, other initial state defaults, or other conditions as will be understood by one of ordinary skill in the art.

During the initial time interval t₁, the DMA controller 46 provides the memory device 42 with control and address signals. After receiving these signals from the DMA controller 46, the memory device 42 puts the requested data (DATA 1) on memory bus 48. The DMA controller 46 reads data packet DATA 1 from the memory bus 48 and stores DATA 1 in the first temporary storage unit 60. Also during t₁, switch 66 is configured to electrically couple the second temporary storage unit 62 with the peripheral bus 50. However, since no data is present in the second temporary storage unit 62 during t₁, no data transfer is made between the second temporary storage unit 62 and the peripheral device 44.

In a second time interval t₂, the switches are reversed such that the first switch 64 couples the second temporary storage unit 62 with the memory bus 48 and the second switch 66 couples the first temporary storage unit 60 with the peripheral bus 50. During this second time interval t₂, a second data packet DATA 2 is read from memory. This data is stored in the second temporary storage unit 62, which was previously empty. Also, the data packet DATA 1, temporarily held in the first temporary storage unit 60 from the previous time interval t₁, is written to the peripheral device 44.

During a third time interval t₃, the state of each switch is again reversed, allowing the memory device to write DATA 3 into the first temporary storage unit 60 and thereby overwriting DATA 1, which had already been transferred to the peripheral device 44 in the time interval t₂ and is no longer needed in temporary storage. DATA 2, which was stored in the second temporary storage unit 62 in the preceding time interval t₂, is written to the peripheral device 44. It should be understood that these steps are repeated for the next data packets until all data has been transferred successfully.

Although the state of the switches 64, 66 is described above as being reversed between some predefined time intervals, the timing of the switch reversals is preferably dependent upon factors other than time. For example, the DMA controller 46 may monitor the residual storage capacity of each temporary storage unit as it is filling and reverse the switches 64, 66 when the currently filling temporary storage unit is full, near full, or at a predetermined threshold. In this manner, when a continuous stream of data is read into the DMA controller 46, the switches can be configured so as to allow each temporary storage unit to fill until a certain level is reached. When no more data can be read into the filling storage unit, the state of the switches is reversed and the other temporary storage unit begins filling. This process of data filling and switch reversing is repeated until the entire stream of data ends.

The end of a data stream provides another situation that warrants the reversal of the switches. In this case, a partially filled temporary storage unit may hold data that has not yet been transmitted out to the peripheral bus 50. If the data stream ends before the temporary storage unit reaches a certain fill level, then means are provides to reverse the switches to transmit the last portion of data to the peripheral device. The DMA controller may monitor when a data stream ends and calculate the length of time that no more data is being read into the presently filling temporary storage unit. When no data is received for a given length of time, the DMA controller 46 again reverses the switches to flush out the data from the partially filled storage unit for transmission to the peripheral device. Before the switches are actually reversed under these conditions, though, the DMA controller 46 monitors the other temporary storage unit to make sure that it is given enough time to transmit all data therefrom.

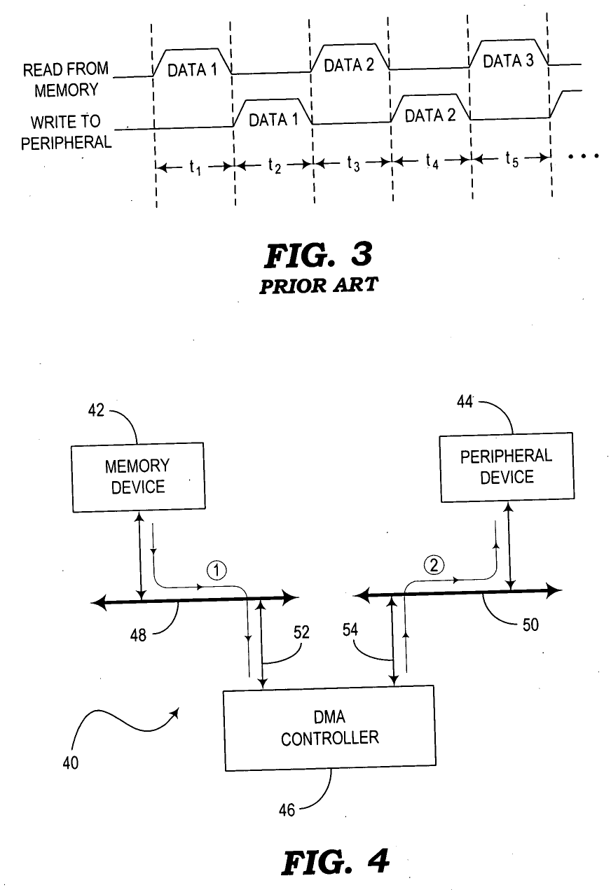

As can be seen from FIG. 6, in comparison with the prior art timing diagram of FIG. 3, the DMA circuit 40, according to the present application, provides a data transfer rate that is substantially twice as fast as the conventional system. Also, the present application provides a system that does not require an increase in operating frequency to accomplish this feat. By splitting the conventional bus into two buses and allowing the DMA controller to read and write simultaneously, the present application is capable of overcoming some of the data transfer bottlenecks of the prior art.

FIG. 7 is a block diagram of a second embodiment of a DMA circuit 70 according to the teachings of the present application. The DMA circuit 70 includes a DMA controller 72 having a number M of memory data paths 74₁, 74₂, . . . , 74_{M} for connection with a corresponding number of memory buses 76₁, 76₂, . . . , 76_{M}, respectively. The memory bus 48 shown in FIG. 4 is split up in this embodiment into a plurality of memory buses 76₁, 76₂, . . . , 76_{M}, each memory bus 76 connected to any number of memory devices (not shown). If desired, the memory buses 76 themselves may be connected with each other via bridges (not shown). With the parallel arrangement of memory buses 76 according to this embodiment, the DMA controller 72 can simultaneously access a memory device from each of the respective memory buses 76 without signal interference.

In addition, the DMA circuit 70 includes a number N of peripheral data paths 78₁, 78₂, . . . , 78_{N} for connection with a corresponding number of peripheral buses 80₁, 80₂, . . . , 80_{N}. In this embodiment of FIG. 7, the peripheral bus 50 shown in FIG. 4 is split up into a plurality of peripheral buses 80₁, 80₂, . . . , 8_{N}, each peripheral bus 80 connected to any number of peripheral devices (not shown). If desired, the peripheral buses 80 may be connected with each other via bridges (not shown). The parallel arrangement of peripheral buses as described herein allows the DMA controller 72 to access a peripheral device from each of the respective peripheral buses 80 simultaneously without signal interference. In this respect, the DMA controller 72 can simultaneously communicate with M memory buses and N peripheral buses. The numbers M and N may preferably be the same, but may be different if desired. In this embodiment, the data transfer process is limited only by the lesser number and/or by the operating frequency of the slowest bus. Therefore, with this system, the data transfer rate may be increased with respect to the conventional rate by a factor up to two times the lesser of M or N.

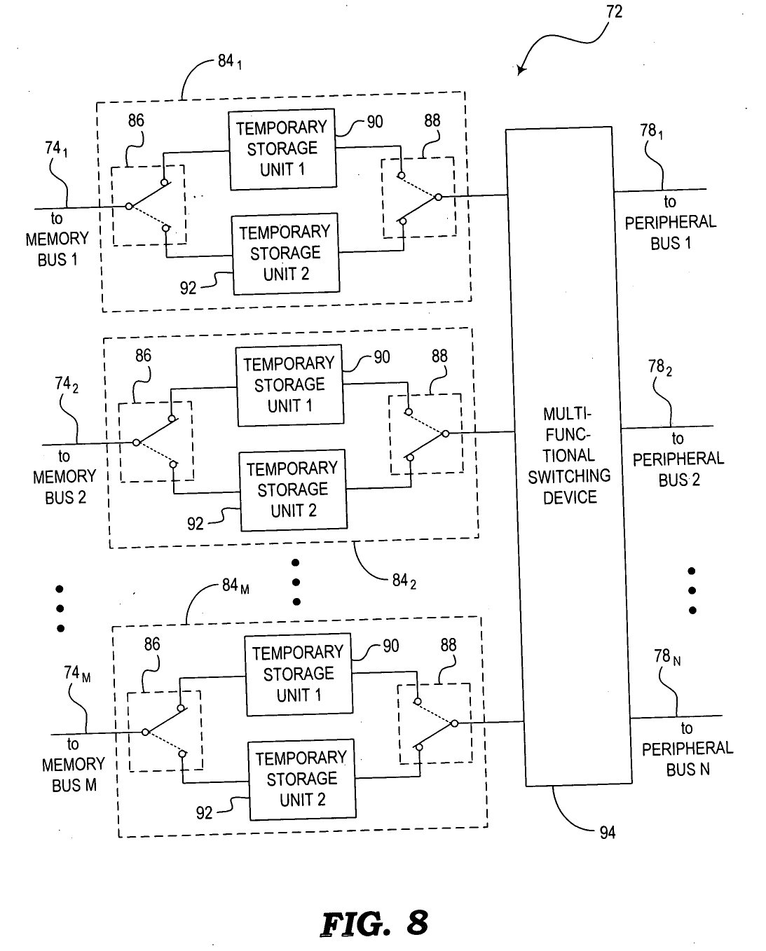

FIG. 8 is a block diagram of an embodiment of the DMA controller 72 shown in FIG. 7. The DMA controller 72 in this embodiment includes a number M of dual storage devices 84₁, 84₂, . . . , 84_{M}, each dual storage device 84 connected to respective memory data paths 74₁, 74₂, . . . , 74_{M}, which in turn are connected to respective memory buses 76₁, 76₂, . . . , 76_{M}. The dual storage devices 84 may be configured in the same way that the single DMA controller 46 of FIG. 5 is configured. Particularly, each dual storage device 84 may include two switches 86, 88 and two temporary storage units 90, 92, allowing one of the temporary storage units to be coupled to the respective memory bus while the other temporary storage unit is coupled to a selected peripheral bus.

The DMA controller 72 may also include a multi-functional switching device 94. Each one of M inputs into the multi-functional switching device 94 is coupled internally with any one of the N peripheral data paths 78₁, 78₂, . . . , 78_{N}, which in turn are connected to the peripheral buses 80₁, 80₂, . . . , 80_{N}, respectively. The multi-functional switching device 94 may contain any suitable combination of logic components or switching components to allow any input to be electrically connected to any output in a one-to-one relationship. If the system is configured such that M equals N, then the internal circuitry of the multi-functional switching device 94 may be configured such that every input is matched up with a corresponding output, thereby allowing a number of simultaneous data transfer stages equal to two times M. If M does not equal N, then some input(s) or output(s) will be left unconnected at any given time and a number of data transfer stages equal to two times the lesser of M or N may be carried out simultaneously.

In an alternative embodiment, the multi-functional switching device 94 may be removed completely from the circuit if, for instance, M is equal to N and each memory bus 76 only accesses a single peripheral bus 80. In this case, the output from each dual storage device 84 would be connected directly to the corresponding peripheral data path 78. In another embodiment, if the computer system is designed such that a certain group of memory buses 76 only access a certain group of peripheral buses 80, then the multi-functional switching device 94 may be divided into smaller, and less complex, switching devices. In this case, each smaller switching device manages only those buses included in a set of corresponding groups. However, in order to maintain the greatest flexibility in terms of connectability between memory devices and peripheral devices, a single multi-functional switching device 94 is used to allow any memory bus 76 to communicate with any peripheral bus 80.

Each dual storage devices 84 allows a memory device on a respective memory bus 76 to continually write data into the two temporary storage units 90, 92 using the switching technique described above. In addition, an electrical coupling is established within the multi-functional switching device 94 to connect any one of the peripheral devices along a corresponding peripheral bus 80 with the output of the dual storage device 84. In this way, a number of data packets equal to the lesser of M or N may be transferred simultaneously from any memory bus to any peripheral bus during each time interval.

In an alternative embodiment, the second switch 88 in the dual storage devices 84 may be removed and replaced by corresponding circuitry within the multi-functional switching device 94. In this respect, sequential data packets from one memory bus may be more easily applied to different peripheral buses if necessary. In yet another embodiment, the set of dual storage devices 84 may be moved to the other side of the DMA controller 72 for direct connection to the peripheral data paths 78 and the multi-functional switching device 94 moved for direct connection to the memory data paths 74. Other circuit configurations may be considered for providing the temporary storage function and switching function of the DMA controller 72 to allow efficient data transfer as described herein without departing from the spirit and scope of the present application.

It should be emphasized that the above-described embodiments of the present application are merely possible examples of implementations set forth for a clear understanding of the principles of the present application. Many variations and modifications may be made to the above-described embodiments without departing substantially from the spirit and scope of the present application. All such modifications and variations are intended to be included herein within the scope of this disclosure and protected by the following claims.

I claim:

1. A direct memory access (DMA) circuit of a master/slave computer system, the DMA circuit comprising:
a memory device;
a peripheral device;
a DMA controller having first and second data paths;
a first bus to which the memory device and the first data path of the DMA controller are connected; and
a second bus to which the peripheral device and the second data path of the DMA controller are connected;
wherein the DMA controller comprises first and second temporary storage units and first and second switches, the first switch providing a first state to electrically couple the first temporary storage unit to the first bus and a second state to electrically couple the second temporary storage unit to the first bus, the second switch providing a first state to electrically couple the first temporary storage unit to the second bus and a second state to electrically couple the second temporary storage unit to the second bus.

2. The DMA circuit of claim 1, wherein the first and second switches are configured at all times such that the first temporary storage unit is coupled to one of the first and second buses and the second temporary storage unit is coupled to the other of the first and second buses.

3. The DMA circuit of claim 2, wherein the first and second switches are configured such that the DMA controller is enable to read one data packet from the memory device and simultaneously write another data packet to the peripheral device.

4. A master/slave computer system comprising the DMA circuit of claim 1.

5. A direct memory access (DMA) controller of a master/slave computer system, the DMA controller comprising:
a first data path connected to a memory bus, the memory bus in communication with at least one memory device;
a second data path connected to a peripheral bus, the peripheral bus in communication with at least one peripheral device; and
means for transferring data between one of the at least one memory device and one of the at least one peripheral device.

6. The DMA controller of claim 5, wherein the means for transferring data comprises means for simultaneously transmitting a first portion of data and receiving a second portion of data.

7. The DMA controller of claim 6, wherein, during a read procedure, the means for transferring data transmits the first portion of data to the peripheral bus and simultaneously receives the second portion of data from the memory bus.

8. The DMA controller of claim 5, wherein the means for transferring data comprises first and second temporary storage units.

9. The DMA controller of claim 8, wherein the means for transferring data further comprises:
means for reading a first data packet from one of the at least one memory device into the first temporary storage unit during a first time interval; and
means for reading a second data packet from the one memory device into the second temporary storage unit during a second time interval, the second time interval being subsequent to the first time interval.

10. The DMA controller of claim 9, wherein the means for transferring data further comprises:
means for transmitting the first data packet from the first temporary storage unit to one of the at least one peripheral device during the second time interval; and
means for transmitting the second data packet from the second temporary storage unit to the one peripheral device during a third time interval, the third time interval being subsequent to the second time interval.

11. The DMA controller of claim 8, wherein the means for transferring data further comprises first and second switches.

12. The DMA controller of claim 11, wherein the means for transferring data further comprises:
means for setting the state of the first switch to electrically couple the memory bus with one of the first and second temporary storage units; and
means for setting the state of the second switch to electrically couple the peripheral bus with the other of the first and second temporary storage units.

13. The DMA controller of claim 5, further comprising:
a first set of data paths connected to a plurality of memory buses, each memory bus in communication with at least one memory device; and
a second set of data paths connected to a plurality of peripheral buses, each peripheral bus in communication with at least one peripheral device;
wherein the means for transferring data simultaneously transfers data between a plurality of memory devices and a plurality of peripheral devices.

14. The DMA controller of claim 13, wherein the means for transferring data further comprises:
a plurality of dual storage devices, each dual storage device connected to a respective memory bus.

15. The DMA controller of claim 14, wherein each dual storage device comprises two temporary storage units and two switches.

16. The DMA controller of claim 14, wherein the means for transferring data further comprises:
a multi-functional switching device connecting an output from each dual storage device with the plurality of peripheral buses.

17. A method for transferring data from one slave to another, the method comprising:
reading a first data packet from a first bus;
temporarily storing the first data packet in a first temporary storage unit; and
writing the first data packet from the first temporary storage unit onto a second bus and simultaneously reading a second data packet from the first bus.

18. The method of claim 17, further comprising:
temporarily storing the second data packet in a second temporary storage unit; and
writing the second data packet from the second temporary storage unit onto the second bus and simultaneously reading a third data packet from the first bus.

19. The method of claim 17, further comprising:
coupling the first bus to one of the first and second temporary storage units while coupling the second bus to the other of the first and second temporary storage units.

20. The method of claim 19, wherein coupling the first and second buses to the first and second temporary storage units further comprises setting the coupling states of first and second switches.

21. The method of claim 20, further comprising:
reversing the coupling states of the first and second switches during a subsequent time interval.

22. The method of claim 21, further comprising:
monitoring the residual storage capacity of the first and second temporary storage units to determine when to reverse the coupling states of the first and second switches.

23. The method of claim 21, further comprising:
monitoring the end of a data stream to determine when to reverse the coupling states of the first and second switches.
